(19) United States
(12) Patent Application Publication
(10) Pub. No.: US 2022/0063960 A1
(43) Pub. Date: Mar. 3, 2022

(54) Control Systems and Methods to Provide Sensor-Based Control

(71) Applicant: Evermore Systems Inc., Austin, TX (US)

(72) Inventor: John Hancock Lupher, Austin, TX (US)

(73) Assignee: Evermore Systems Inc., Austin, TX (US)

(21) Appl. No.: 17/011,708

(22) Filed: Sep. 3, 2020

(51) Int. Cl. B66B 9/08; E04F 11/06; G06K 9/00; G06K 9/62

(52) U.S. Cl. CPC B66B 9/0869; B66B 9/0823; G06K 9/6267; G06K 9/00771; E04F 11/068

(57) ABSTRACT

A system includes an input/output (I/O) interface, a processor coupled to the I/O interface, and a memory accessible to the processor. The I/O interface may be configured to receive data from one or more sensors and to provide control signals to one or more actuators. The memory may store instructions that, when executed, cause the processor to receive sensor signals from the one or more sensors and send actuator signals to the one or more actuators to control movement of a plurality of discrete stair lifts of a staircase based on the received sensor signals.

### FIELD

The present disclosure is generally related to control systems and methods to provide sensor-based controls, and more particularly to systems and devices configured to control staircase systems including discrete stair lifts, moving systems, and other actuatable systems.

### BACKGROUND

Sometimes, individuals may have disabilities or injuries that make climbing stairs difficult. Assistive technologies, such as stair lift chairs and elevators, are sometimes installed to assist such individuals.

### SUMMARY

Systems and methods described below may include a staircase system including a plurality of discrete stair lifts, each of which may be independently controlled to provide a selected elevation. The storage system may include a control system configured to control the movement of each of the stair lifts both in terms of the timing and the extent of elevation. As used herein, the phrase “discrete stair lift” or “stair lift” refers to a step or stair of a staircase that can be moved vertically independent of other steps or stairs of the staircase. The plurality of discrete stair lifts may be controlled to selectively change elevations to raise or lower, for example, as a person, pet, or object moves laterally.

In some implementations, the control system may include or may be coupled to each of the discrete stair lifts and to a plurality of sensors, including one or more of optical sensors, radio detection and ranging (RADAR) sensors, light detection and ranging (LIDAR) sensors, acoustic sensors (e.g., microphones), other sensors, or any combination thereof. The control system may be configured to detect movement proximate to the staircase system based on signals from one or more of the sensors. The control system may selectively control one or more of the discrete stair lifts in response to the received signals.

In some implementations, the control system may determine movement including both speed and direction based on signals from one or more of the sensors. Additionally, the control system may classify an entity associated with the movement based on optical data determined from the one or more sensors. For example, the control system may process the optical data to differentiate between a pet and a human; between a baby, a toddle, a teenager, and an adult; between an authorized person and an unauthorized person; or any combination thereof. The system may determine a selected staircase control operation based on the classification data. In some implementations, the control system may selectively control one or more of a plurality of discrete stair lifts to provide the selected operation.

In some implementations, the control system may be configured to implement a variety of operations based on the detection and classification of data received from the sensors. For example, the control system may independently control one or more steps of a staircase to implement a discrete step lift operation, a platform lift operation, a security operation, another operation, or any combination thereof.

In the discrete stair lift operation, each step of the staircase may be independently controlled to raise or lower the step in order to provide a lift operation that allows the person to travel up or down while walking forward, as the stairs align to provide a smooth path along which the user walks. As the user walks forward, the steps are moved to alter the elevation of the user according to the speed of the user.

In a platform lift operation, a subset of discrete stair lifts (steps or stairs) may be aligned to form a virtual platform, and selected steps may be raised or lowered to change the elevation of an object. For example, several discrete stair lifts may be adjusted to a first level to form a platform. A person may move a dresser, a wheelchair, or other object onto the platform. The control system may then adjust the elevation of the platform and the elevation of other discrete stair lifts to raise or lower the dresser or other object to a second elevation. The user may then move the object across the discrete stair lifts to complete the transfer from the first elevation to the second elevation. For example, the user may place a dresser on the platform on the first floor, and the control system may raise the platform and the other discrete stair lifts to the elevation of the second-floor level. The user may move the dresser off the platform and across the discrete stair lifts onto the second floor. In some implementations, the user may carry or slide the object and the control system may automatically control the discrete stair lifts to provide the lift operation as the user moves laterally, timing the movement of the discrete stair lifts to match the lateral speed of the user.

In a security-type of operation, the control system may determine the entity approaching the stairs. In an example, based on optical data, the control system may differentiate between a pet or a toddler. The control system may determine one or more security protocols in response to determining the entity. For example, the security protocols may be designed to prevent a pet from climbing the stairs. As a pet approaches the staircase, the control system may raise or lower one or more of the discrete stair lifts to present a pet barrier. Similarly, in response to detecting a toddler approaching the staircase, the control system may raise or lower one or more of the discrete stair lifts to present a barrier to the toddler. The same or a similar technique may be used to present a barrier to an intruder as well. If the control system determines that a person is not authorized to access the upstairs (for example, by comparing image data of the person to stored image data associated with authorized users), the control system may raise or lower one or more of the discrete stair lifts of the staircase to present a barrier. If the control system recognizes the person as being authorized (such as by determining a match between the optical data and previously stored optical data of the user), the control system may control the steps as previously discussed to provide a discrete stair lift operation. Other implementations are also possible.

In some implementations, the control system may receive sensor data from a plurality of sensors, including microphones, cameras, motion detectors, other sensors, or any combination thereof. The sensor data may include images, sounds, movement, and other data. The control system may determine one or more parameters from the sensor data. The parameters may include size, speed, biometric data, facial data, proximity data, direction data, gesture data, sound data, other data, or any combination thereof. The control system may selectively or automatically control the staircase system based in part on the one or more parameters. Other implementations are also possible.

### BRIEF DESCRIPTION OF THE DRAWINGS

The detailed description is set forth with reference to the accompanying figures. In the figures, the left most digit(s) of a reference number identifies the figure in which the reference number first appears. The use of the same reference numbers in different figures indicates similar or identical items or features.

FIG. 1 depicts a block diagram of a system to provide sensor-based control, in accordance with certain embodiments of the present disclosure.

FIG. 2 depicts a perspective view of a staircase including a plurality of movable stairs (discrete stair lifts) that can be controlled by the system of FIG. 1.

FIG. 3 depicts a perspective view of a staircase including a plurality of discrete stair lifts that can be adjusted to provide a platform that can be raised or lowered or to render the stairs inaccessible.

FIG. 4 depicts a side view of a plurality of discrete stair lifts of a staircase that can be controlled by the system of FIG. 1.

FIG. 5 depicts a front view of a step of the staircase of FIG. 5 including actuators to adjust an elevation of the discrete stair lift.

FIG. 6 depicts a flow diagram of a method of initiating one or more actions in response to detecting movement, in accordance with certain embodiments of the present disclosure.

FIG. 7 depicts a flow diagram of a method of initiating one or more actions in response to detecting movement, in accordance with certain embodiments of the present disclosure.

FIG. 8 depicts a flow diagram of a method of implementing different protocols in response to detecting movement, in accordance with certain embodiments of the present disclosure.

While implementations are described in this disclosure by way of example, those skilled in the art will recognize that the implementations are not limited to the examples or figures described. The figures and detailed description thereto are not intended to limit implementations to the form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the work “may” is used in a permissive sense (in other words, the term “may” is intended to mean “having the potential to”) instead of in a mandatory sense (as in “must”). Similarly, the terms “include”, “including”, and “includes” mean “including, but not limited to”.

### DETAILED DESCRIPTION OF ILLUSTRATIVE EMBODIMENTS

Systems and methods described below may include a staircase system including a plurality of discrete stair lifts (or stairs) and a control system configured to control the movement of each of the discrete stair lifts both in terms of the timing and the extent of elevation. In some implementations, the control system may include or may be coupled to a plurality of sensors, including one or more of optical sensors, radio detection and ranging (RADAR) sensors, light detection and ranging (LIDAR) sensors, acoustic sensors (e.g., microphones), other sensors, or any combination thereof. Each of the discrete stair lifts may include a step or stair and one or more actuators responsive to control signals from the control system to adjust an elevation of the step or stair. Additionally, each of the discrete stair lifts may include a telescoping riser that may extend or retract as the step or stair is raised or lowered to provide an aesthetic cover, to prevent injury, and to prevent debris or other items from impeding movement of the steps.

In some implementations, the control system may determine movement including both speed and direction based on signals from one or more of the sensors. The control system may control the amplitude and timing of movements of each of the discrete stair lifts independently to match the lateral speed of the person.

In some implementations, the control system may be configured to implement a variety of operations based on the detection and classification of data received from the sensors. For example, the control system may independently control one or more discrete stair lifts of a staircase to a discrete stair lift operation, a platform lift operation, a security operation, another operation, or any combination thereof.

In the discrete stair lift operation, each step of the staircase may be independently controlled to raise or lower the step in order to provide a lifting operation that allows the person to travel up or down while walking forward, as the stairs align to provide a smooth path along which the user walks. As the user walks forward, the steps are moved to alter the elevation of the user and to dynamically provide a smooth walkway by matching the movement of the discrete stair lifts to the lateral speed of the user.

In a platform lift operation, a set of steps may be aligned to form a virtual platform, and selected steps may be raised or lowered to change the elevation of an object. For example, several discrete stair lifts of the staircase may be adjusted to a first level to form a platform. A person may move a dresser, a wheelchair, or another object onto the platform. The control system may then adjust the elevation of the platform and the elevation of other discrete stair lifts to raise or lower the dresser or other object to a second elevation. The user may then slide the object across the steps to complete the transfer from the first elevation to the second elevation. For example, the user may place a dresser on the platform on the first floor, and the control system may raise the platform and the other discrete stair lifts to the second floor. The user may move the dresser off the platform onto the second floor. In some implementations, the user may carry or slide the object and the control system may automatically control the steps to provide the lift operation as the user moves laterally. Other implementations are also possible.

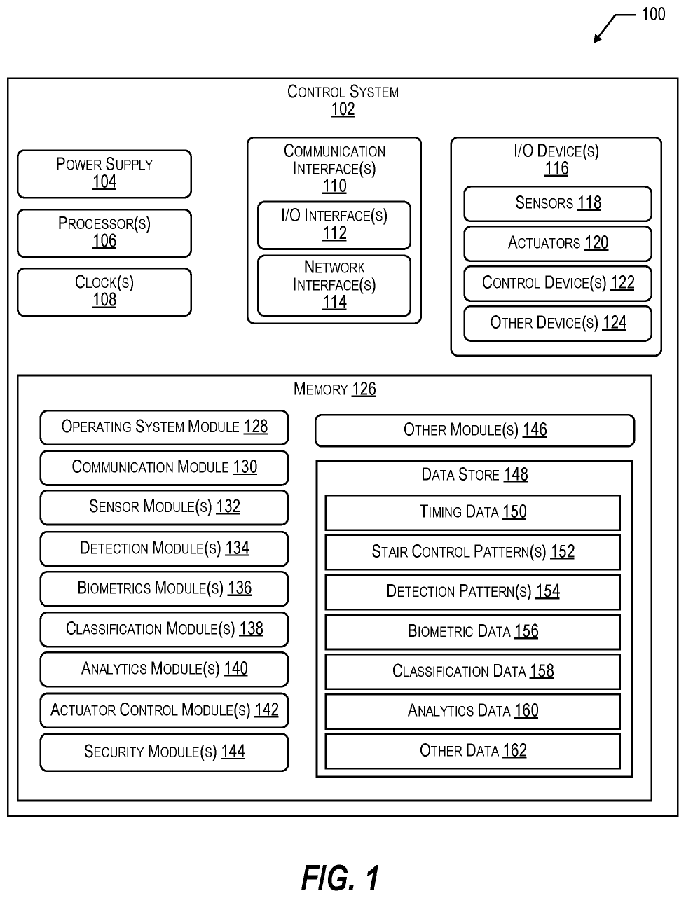

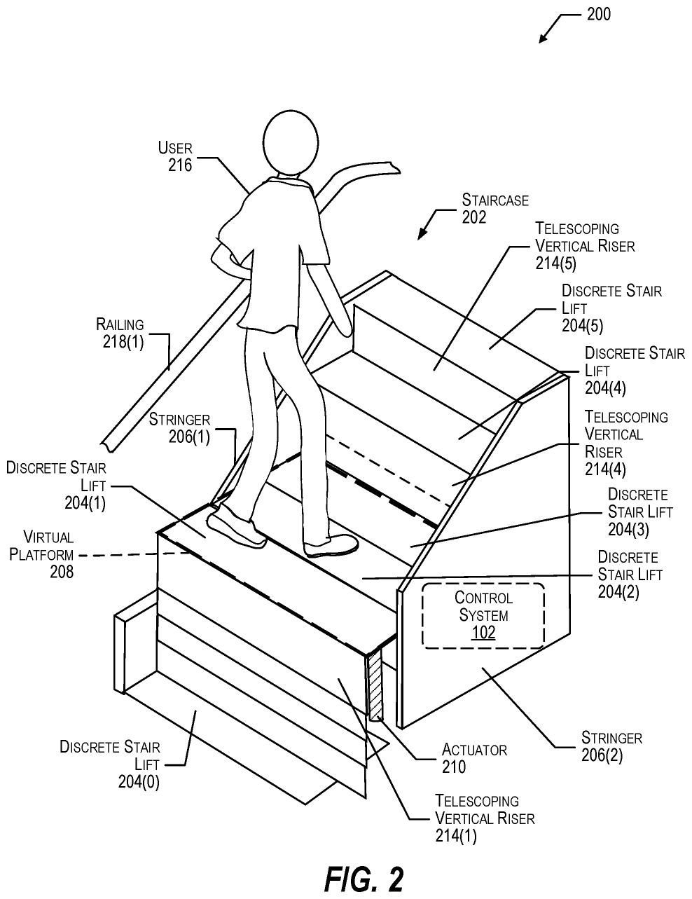

FIG. 1 depicts a block diagram of a system 100 to provide sensor-based control, in accordance with certain embodiments of the present disclosure. The system 300 may be configured to utilize sensor data to determine data that may be used to control one or more discrete stair lifts (steps) of a staircase system, such as the staircase system 200 of FIG. 2, to provide selected functionality. The system 100 may be configured to selectively activate one or more of a plurality of discrete stair lifts of the staircase system 200 based on one or more sensor signals.

The system 100 may include a control system 102, which may include a power supply 104 to provide power to the various components. The control system 102 may also include one or more processors 106 that may be configured to execute processor-readable instructions and to process data. The control system 102 may also include one or more clocks 108 that may provide timing signals that may be used by the one or more processors 106 and optionally by other components.

The control system 102 may include one or more communication interfaces 110, including one or more input/output (I/O) interfaces 112. The I/O interfaces 112 may be coupled to or may communicate (such as through radio frequency wireless signals) with one or more I/O devices 116. The I/O devices 116 may include one or more sensors 118, one or more actuators 120, one or more control devices 122, one or more other devices 124, or any combination thereof. The sensors 118 may include optical sensors, radio detection and ranging (RADAR) sensors, light detection and ranging (LIDAR) sensors, pressure sensors, proximity sensors, microphones, other sensors, or any combination thereof. The actuators 120 may include motors, pneumatic devices, screw drives, transducers (that may translate electrical signals into movement), other devices, or any combination thereof. The control devices 122 may include a touchscreen, a keypad, a smartphone, a tablet computer, a remote-control device, other devices, or any combination thereof. The other devices 124 may include lights, speakers, locking mechanisms, other electronic devices, or any combination thereof.

The communication interfaces 110 may also include one or more network interfaces 114. The network interfaces 114 may include wired communication interfaces, such as Ethernet ports to receive an RJ45 connector, Universal Serial Bus (USB) ports to receive USB connectors, one or more other serial interfaces, other network communication interfaces, or any combination thereof. The network interfaces 114 may also include radio frequency (RF) wireless communication interfaces, such as transceivers that may send and receive data to and from a communications network. Such transceivers may support various RF protocols including Bluetooth® protocols, Institute of Electrical and Electronics Engineers (IEEE) protocols (such as IEEE 802.11x protocols), other RF protocols, or any combination thereof.

The control system 102 may include a memory 126, such as a flash memory, a hard disc drive, or other non-volatile memory, which may store data and processor-readable instructions that may be executed by the one or more processors 106 to perform a variety of functions. The memory 126 may include one or more operating system modules 128 that may be executed by the processor 106 to control overall operation of the control system 102. The memory 126 may also include one or more communication modules 130 that, when executed, may cause the processor 106 to control data flow to and from the one or more communication interfaces 110.

The memory 126 may include one or more sensor modules 132 that, when executed, may cause the processor 106 to receive data from the one or more sensors 118. In some implementations, the sensor modules 132 may cause the processor 106 to send a signal to one or more of the sensors 118 and to receive data indicative of a sensed parameter in response thereto.

The memory 126 may include one or more detection modules 134 that, when executed, may cause the processor 106 detect movement, direction of movement, proximity, speed, size, gestures, sounds, images, or other parameters based on signals from the one or more sensors. The detection modules 134 may detect movement or sound proximate to a staircase system comprising a plurality of discrete stair lifts.

The memory 126 may include one or more biometrics modules 136 that, when executed, may cause the processor 106 to determine biometric data from the data received from the sensors 118. Such biometric data may include fingerprint scans, facial image data, retinal image data, hand geometry, palm vein data, ear shape data, voice data, other data, or any combination thereof. In some implementations, the biometrics modules 136 may cause the processor 106 to compare the biometric data from the sensors to previously stored biometric data. Such comparisons may be used to authenticate a user such as by determining whether the received biometric data matches the stored data with an acceptable degree of confidence (i.e., within a margin of error).

The memory 126 may include one or more classification modules 138 that, when executed, may cause the processor 106 to determine one or more objects or entities based on data from the sensors 118 (such as optical data or other data). In some implementations, the classification modules 138 may differentiate between a toddler, a child, and an adult; between authorized individuals and unauthorized individuals; between pets and humans; between pets and other animals; or any combination thereof. The classification modules 138 may compare optical data from the sensors 118 to stored optical data to determine whether a human or a pet is known (authorized) or unknown (unauthorized). In an example, the classification module 138 may utilize facial recognition techniques to compare image data from the sensors 118 to stored images to verify that a human is known and authorized. Changes to the user's appearance (e.g., hair color, style, or other changes, including plastic surgery) may be accommodated by updating stored images or by utilizing multiple recognition protocols (including facial markers, biometrics, gait, and other optically detectable identifiers). In other examples, the classification module 138 may utilize image processing techniques to detect a gesture indicative of a command. In still other examples, the classification module 138 may determine a voice command and may utilize voice print analysis to determine whether the voice command is authorized.

In some implementations, the classification modules 138 may rely on optical data as well as radio frequency data from a transceiver embedded in or attached to a collar of a pet. In other implementations, the classification modules 138 may cause the processor 106 to determine objects, such as wheelchairs, canes, and other assistive technologies, and may select a platform lift protocol to control the discrete stair lifts to provide a platform to raise or lower a person using the assistive technology. Other implementations are also possible.

The memory 126 may include one or more analytics modules 140 that, when executed, may cause the processor 106 to process image data to validate a person and to update biometric data 156 in a data store 148 to include updated optical data (e.g., recent image data) so that the control system 102 adapts to changes in the person's appearance (hair color, hair style, height, and so on). The analytics module 140 may cause the processor 106 to determine actions to be initiated based on data from the detection modules 134, the biometric modules 136, and the classification modules 138, and other data. Such other data may include user-defined rules, historical data, other data, or any combination thereof.

The memory 126 may include one or more actuator control modules 142 that, when executed, may cause the processor 106 to determine one or more actuators 120 to be controlled. The actuators 120 may be selected from a plurality of actuators 120. The actuator control modules 142 may also determine one or more signals to be communicated to the selected actuators 120 to perform a selected operation, such as raising or lowering one or more discrete stair lifts of a staircase. The control signals may control an elevation to which a selected discrete stair lift is raised. Moreover, the actuator control modules 142, when executed, may cause the processor 106 to control each discrete stair lift of a plurality of discrete stair lifts of a staircase independently. In some implementations, the actuator control modules 142 may cause the processor 106 to control the timing of actuation, the amplitude of the movement, the speed of the movement, and so on. In some examples, the actuator control modules 142 may cause the processor 106 to determine a discrete stair lift operation based on the sensor signals from the one or more sensors 118, The actuator control modules 142 may cause the processor 106 to determine a speed of a user approaching the staircase and selectively adjust an elevation of a subset of the plurality of discrete stair lifts to a first elevation corresponding to an elevation associated with the user. The analytics module 140 may cause the processor 106 to monitor the speed of the user, and the actuator control modules 142 may cause the processor 106 to selectively adjust the elevation of the subset and of one or more of the plurality of discrete stair lifts to lift the user from the first elevation to a second elevation as the user moves laterally.

The memory 126 may include one or more security modules 144 that, when executed, may cause the processor 106 to determine a security event, such as an unauthorized entity approaching the stairs (a toddler, a pet, an intruder, a house guest, and so on). In response to detecting the security event, the one or more security modules 144 may cause the processor 106, using the actuator control modules 142, to raise or lower one or more discrete stair lifts of a staircase, presenting a barrier. For example, by lowering all the steps to a ground floor level or by raising selected steps, the staircase may be rendered inaccessible and may present a vertical barrier. In an example, the security modules 144 may cause the processor 106 to detect a toddler approaching the staircase, which may represent a security event. In response, the control system 102 may raise or lower one or more of the discrete stair lifts to prevent the toddler from using the staircase.

In some implementations, the control system 102 may generate an alert in response to a security event. The alert may include an audible sound, a change in lighting, a text message, a phone call, an email message, another signal, or any combination thereof. Other implementations are also possible.

The memory 126 may include one or more other modules 146 that, when executed, may cause the processor 106 to perform other functions. Such functions may include generating audio signals to be reproduced by one or more speakers, flashing lights, and so on. Other implementations are also possible.

The memory 126 may include a data store 148 to store data associated with one or more of the sensors 118 and with detected entities. The data store 148 may include timing data 150, stair control pattern data 152, detection pattern data 154, biometric data 156, classification data 158, analytics data 160, other data 162, or any combination thereof. The timing data 150 may include activation or deactivation delays as well as timing associated with movement of an entity toward the stairs. The stair control pattern data 152 may include one or more patterns with respect to timing of the raising or lowering of each discrete step of the plurality of steps to provide a selected platform or stair profile. The detection pattern data 154 may include optical patterns, radar patterns, lidar patterns, voice patterns, gestures, or any combination thereof that may be used to determine a control event.

In some implementations, one of the sensors 118 (e.g., a microphone) may receive an audio signal that includes an instruction or command, and the control system 102 may evaluate the command against one or more detection patterns to authenticate the speaker, to determine the command, and so on. In some implementations, the detection pattern may be used to evaluate optical data to perform facial recognition, to determine a gesture, or to recognize an evolving scenario, such as an authorized user approaching the stairs.

In some implementations, elevations of each of the discrete stair lifts of the staircase may be independently controlled to facilitate the user advancing from a first floor to a second floor such that the user may continue walking on a seemingly horizontal plane as the discrete stair lifts change elevation to raise or lower the user. The detection pattern 154 may include detecting a user, determining one or more user preferences, and adjusting the stairs according to the determined user preferences. In this example, the detection pattern 154 may include signals from one or more other modules, including user authentication from the biometrics module 136, user differentiation from the classification module 138, speed and direction from the sensor modules 132, and so on. The control system 102 may selectively activate one or more actuators 120 and control timing of such activations so that actions may correspond with the movement of a user according to the preferences.

In an example, the control system 102 may determine that the person approaching the stairs is in a wheelchair. In response, the control system 102 may lower selected discrete stair lifts to provide a virtual platform and may raise the virtual platform and adjust the elevations of other discrete stair lifts as the user moves laterally to raise the user from a first floor to a second floor. It should be appreciated that the control system 102 may also operate in reverse to lower a person from the second floor to the first floor.

In some implementations, the control system 102 may detect a person walking toward the stairs. In response, the control system 102 may selectively adjust the elevations of one or more discrete stair lifts to provide a smooth surface to receive the user and may adjust the elevations of those stair lifts and other discrete stair lifts to raise the user (or lower the user) from a first level to a second level (or vice versa) as the user walks. In some implementations, this raising or lowering operation may be performed at a rate that enables the user to traverse the staircase without climbing the steps and without breaking stride.

FIG. 2 depicts a perspective view of a staircase system 200 including a staircase 202 formed of a plurality of discrete stair lifts 204 that can be controlled by the control system 102 of FIG. 1. Each discrete stair lift 204 may include a vertical riser 214, which may telescope or extend and retract as the step 204 is raised or lowered. The discrete stair lift 204 may be secured between or framed by stringers 206(1) and 206(2). The staircase system 200 may also include a plurality of actuators 210, at least one of which may be positioned under each discrete stair lift 204 and hidden by the vertical riser 214. The actuators 210 may be implementations of the actuators 120 in FIG. 1. The actuators 210 may be controlled by electrical signals provided by the control system 102 to raise or lower the associated discrete stair lift 204.

In some implementations, the control system 102 may be positioned under the staircase 202. In an alternative embodiment, the control system 102 may be at another location but may be in communication with the actuators 210 and the one or more sensors 118 through wired or wireless communications links.

In some implementations, the staircase system 200 may further include railings 218, such as the railing 218(1). Depending on the implementation, the staircase system 200 may include a first railing 218, which may be fixed at a fixed or default height relative to the discrete stair lifts (or steps) 204, and which may be coupled to a structure, such as a wall. The staircase system may also include a second railing 218, which may be coupled to the discrete stair lifts 204. The second railing 218 may raise or lower with the discrete stair lift 204 to provide a stable handle for a user traversing the moving steps.

In some implementations, as the user 216 walks toward the staircase 202, the control system 102 may detect the user's approach and may adjust the elevations of two or more of the discrete stair lifts 204 to establish a virtual platform 208. The control system 102 may detect the user 216, determine one or more parameters associated with the user (e.g., optical data, voice data, and so on), may compare the one or more parameters to data within the data store 148 in FIG. 1, and may adjust the elevations of selected discrete stair lifts 204 to provide a vertical assist to the user 216. In this example, the user 216 may continue to walk in a forward direction and the control system 102 may control selected ones of the discrete stair lifts 204 to elevate the user from a first elevation to a second elevation as the user 216 walks. Thus, the user 216 may scale the staircase 202 without having to climb the stairs.

In the illustrated example, the user is walking along a horizontal platform, which is changing elevations and dynamically changing by adding discrete stair lifts 204 in front of the user to lift the user up the staircase 202 as the user walks and at a rate that corresponds to the user's lateral velocity. Thus, the discrete stair lifts 204(1) and 204(2) may initially be lowered to provide a planar surface together with the discrete stair lift 204(0). Once the user 216 advances (walks or rolls) onto the virtual platform 208, the control system 102 may raise the discrete stair lift 204(0), 204(1), and 204(2) to a second elevation and lower the discrete stair lift 204(3) to the second elevation. Once a top surface of the discrete stair lift 204(3) is aligned with the surfaces of the discrete stair lift 204(1) and 204(2) and the user has moved off the discrete stair lift 204(0), the discrete stair lift 204(0) may return to its default elevation. The virtual platform 208 represents this configuration. The virtual platform 208 includes discrete stair lift 204(1), 204(2), and 204(3).

As the user continues to advance, the control system 102 may raise discrete stair lift 204(1), 204(2), and 204(3) to a next elevation, and may lower discrete stair lift 204(4) to the next elevation to extend the virtual platform 208. The discrete stair lift 204(1) may then be returned to its default position as a next stair, discrete stair lift 204(5) may begin moving toward the selected elevation. The process may be repeated with adjacent stairs until the virtual platform 208 reaches its final elevation. In some implementations, the railings 218 may also move with the discrete stair lift 204, providing support for the user 216 as the virtual platform 208 moves.

In the illustrated example, a single user 216 is moving up the staircase 202 on the virtual platform 208. The discrete stair lift 204 may be moved vertically, such that the virtual platform 208 moves vertically at a rate that is proportional to a rate of lateral movement of the user 216. If the user stops, the virtual platform 208 may also stop. In other embodiments, the control system 102 may advance the virtual platform 208 according to a predetermined timing. In some implementations, once the virtual platform 208 begins moving, the virtual platform 208 may move continuously from a first level to a second level. Other implementations are also possible.

While the illustrated example depicts a virtual platform 208 comprised of three discrete stair lifts 204, in other implementations, more than three discrete stair lifts 204 may be lowered or raised at the same time to provide an adjustable platform size. The number of discrete stair lifts 204 used to provide the virtual platform 208 may be dynamically selected based on the speed of movement of the user, the size of an object to be lifted, preprogrammed platform size selections, other parameters, or any combination thereof. Additionally, each discrete stair lift 204 may be raised or lowered to a selected elevation independent of any other step.

While only one user 216 is shown, the staircase system 200 may be configured to provide a second virtual platform 208 at either end of the staircase 202. In some implementations, a first user 216(1) may move from a first level to a second level, while a second user 216(2) may move from a second level to a first level concurrently. The virtual platforms 208 may temporarily overlap as the users pass one another. Other implementations are also possible.

The staircase system 200 provides several advantages over conventional assisted movement systems, such as escalators, elevators, and the like. First, because each discrete stair lift 204 may be adjusted independently, the amount of power needed to move the discrete stair lift 204 is much smaller than the amount of power needed to move a carriage (such as an elevator). Additionally, the discrete stair lift 204 may be moved independently and discretely, making it possible to have multiple virtual platforms 208 concurrently, moving in the same direction or in opposite directions or to provide elevator-type lift services, depending on the context. Unlike an elevator or lift, a user need not wait for the carriage to return to a starting position to make use of the lifting operation. Instead, the user may approach the discrete stair lift as needed, and the staircase system 200 may respond automatically to carry the user between elevations. In some implementations, a further advantage may be realized in that the staircase system 200 may be implemented as a spiral staircase or in other form factors, depending on the implementation. The form-factor versatility enables installation in small spaces or within existing form factors.

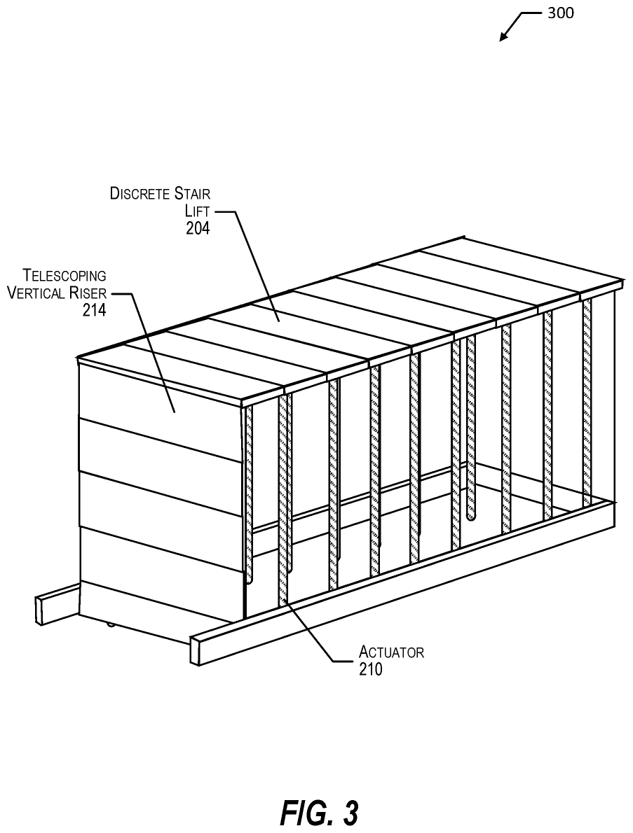

While the example of FIG. 2 represents an implementation where the user 216 is authorized or where the control system 102 controls the staircase system 200 based on detecting movement and not necessarily based on authorization or other security parameters. In an example where the user 216 is not authorized or the detected entity is a pet or a toddler, the staircase system 200 may be controlled (by control system 102) to present a barrier to prevent the pet, toddler, or intruder from accessing the second floor via the staircase 202. An example of the control system 102 elevating one or more of the discrete stair lifts 204 to present a barrier is described below with respect to FIG. 3.

FIG. 3 depicts a perspective view 300 of a staircase system 200 including a plurality of discrete stair lifts 204 that can be adjusted to provide a platform that can be raised or lowered or to render the stairs inaccessible. In this example, each discrete stair lift 204 (or selected discrete stair lifts 204) may be raised or lowered from a first elevation corresponding to a first floor to a second elevation corresponding to a second floor or an intermediate level, such as the level of a staircase landing. In this example, the terms “first” and “second” are used to differentiate between floors and do not indicate any order or arrangement.

In response to detecting an intruder, pet, or toddler approaching the staircase 202, the control system 102 may implement a selected security protocol to present a barrier. In this example, all the discrete stair lifts 202 are raised and the telescoping vertical risers 214 are extended to present a barrier.

In this example, the stringers 206 are depicted as boards that encase the bottom of the staircase 202; however, in some implementations, the stringers 206 or another component may telescope as the discrete stair lifts 204 are raised so that the actuators 210 are enclosed. In other implementations, each discrete stair lift 204 may include a telescoping side riser to raise or lower with the step so that the actuators 210 are enclosed.

Each actuator 210 may include one or more motors, one or more screw drives, other devices, or any combination thereof. In this example, each discrete stair lift 204 is raised or lowered by a pair of actuators 210, spaced apart underneath each discrete stair lift 204 to provide support and stability as the discrete stair lift 204 is raised or lowered. Each pair of actuators 210 may be configured to raise or lower the discrete stair lift 204 between a first-floor elevation and a second-floor elevation and may be controlled to stop at intermediate elevations. The actuators 210 may move each discrete stair lift 204 and maintain each discrete stair lift 204 at a selected elevation between the first floor and the second floor. If power is lost during operation, the actuators 210 may continue to support the discrete stair lift 204 at its current elevation. Upon restoration of power, the actuators 210 may be controlled to move the discrete stair lifts 204.

In this example, the virtual platform provided by the discrete stair lift 204 may also be used to lift or lower an object between the first floor and the second floor. This implementation may be used to simplify moving furniture between floors. Additionally, the lift functionality may facilitate movement of a handicapped individual, enabling elevator-type functionality for individuals who may otherwise struggle to climb stairs. Similarly, this functionality may provide a service elevator-type of lift for carrying furniture and other heavy items between floors. In still another implementation, selected discrete stair lifts 204 may be elevated to allow a homeowner to change a lightbulb in a fixture above the stairs. Other implementations are also possible.

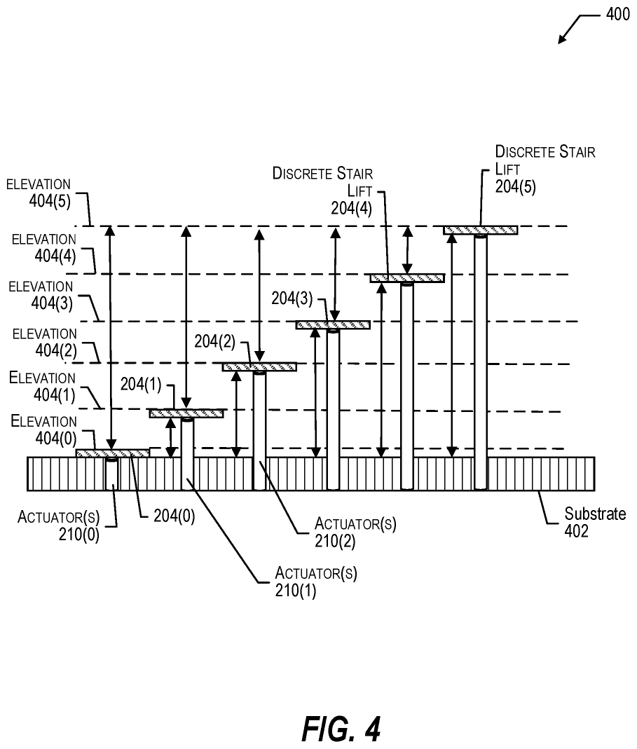

FIG. 4 depicts a side view of portion 400 of the staircase system 200 of FIG. 3 that can be controlled by the control system 102 of FIG. 1. The staircase system 200 may include a plurality of actuators 210. One or more actuators 210 may be controlled to move each discrete stair lift 204 of the staircase 202 discretely and independently relative to the other discrete stair lifts 204, in accordance with certain embodiments. In this example, each of the discrete stair lifts 204 is coupled to one or more actuators 210, which are positioned beneath the discrete stair lift 204. The one or more actuators 210 may operate to raise or lower the discrete stair lift 204 to a selected elevation 404 and to secure the discrete stair lift 204 at a selected elevation.

The staircase system 200 may include a first discrete stair lift 204(0) coupled to one or more actuators 210(0), which may be recessed into a substrate 402, such as the floor. The one or more actuators 210(0) may raise the discrete stair lift 204(0) from a first elevation 404(0) to a second elevation 404(1) and optionally to a third elevation 404(2), a fourth elevation 404(3), a fifth elevation 404(4), or a sixth elevation 404(5). Any number of elevations may be accommodated.

The staircase system 200 may include a second discrete stair lift 204(1) coupled to one or more actuators 210(1), which may be recessed into or coupled to the substrate 402. The one or more actuators 210(1) may move the second discrete stair lift 204(1) between a first elevation 404(0) and the sixth elevation 404(5), or any elevation 404 therebetween. In some implementations, the second elevation 404(1) may be a default elevation for the second discrete stair lift 204(1).

The staircase system 200 may include a third discrete stair lift 204(2) coupled to one or more actuators 210(2), which may be recessed into or coupled to the substrate 402. The one or more actuators 210(2) may move the third discrete stair lift 204(2) between the first elevation 404(0) and the sixth elevation 404(4). The third elevation 404(2) may be a default elevation for the third discrete stair lift 204(2).

The staircase system 200 may include a fourth discrete stair lift 204(3) coupled to one or more actuators 210(3), which may be recessed into or coupled to the substrate 402. The one or more actuators 210(3) may move the fourth discrete stair lift 204(3) between the first elevation 404(0) and a sixth elevation 404(5). The fourth elevation 404(3) may be a default elevation for the fourth discrete stair lift 204(3).

The staircase system 100 may include a fifth discrete stair lift 204(4) coupled to one or more actuators 210(4), which may be recessed into or coupled to the substrate 402. The one or more actuators 210(4) may move the fifth discrete stair lift 204(4) between the first elevation 404(0) and the sixth elevation 404(5). The fifth elevation 404(4) may be a default elevation for the fifth discrete stair lift 204(4).

The staircase system 100 may include a sixth discrete stair lift 204(5) coupled to one or more actuators 210(5), which may be recessed into our coupled to the substrate 402. The one or more actuators 210(5) may move the fifth discrete stair lift 204(4) between the first elevation 404(0) and the sixth elevation 404(5). The sixth elevation 404(5) may be a default elevation for the sixth discrete stair lift 204(5).

While in this example, some of the steps, such as the third discrete stair lift 204(2) may be moved between five different elevations 404, in other implementations, the discrete stair lifts 204 may be moved between three elevations 404. Further, it should be appreciated that the discrete stair lifts 204 may transition between elevations 404. The elevations 404(0) through 404(5) are provide for illustrative purposes only, and the one or more actuators 210 may move the discrete stair lifts 204 to a selected elevation, which may correspond to one of the illustrative elevations 404(0) through 404(5) or to another intermediate elevation. Other implementations are also possible.

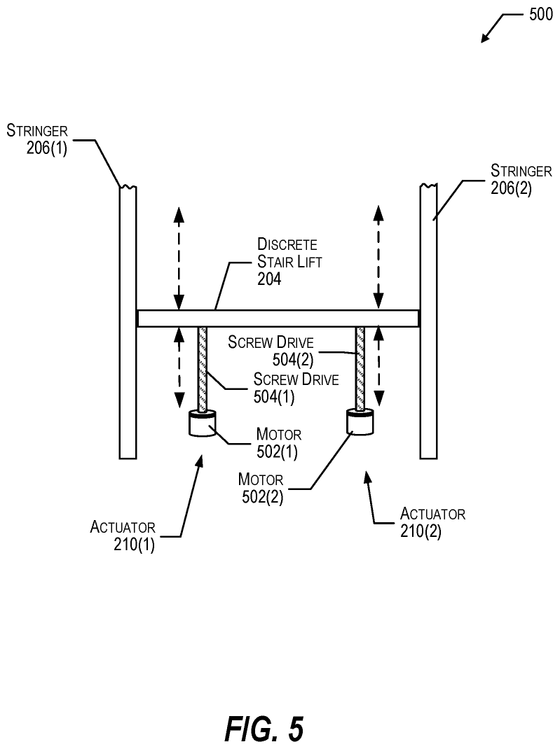

FIG. 5 depicts a front view 500 of a portion of a discrete stair lift 204 of the staircase system 202, in accordance with certain embodiments. The discrete stair lift 204 may include two actuators 210(1) and 210(2) arranged symmetrically beneath the discrete stair lift 204. In this example, each actuator may be comprised of a motor 502 and a screw drive 504 that may raise or lower the discrete stair lift 204 based on a direction of rotation of the crew drive 504. In an alternative embodiment, the motor 502 may turn a gear that engages a chain configured to raise and lower the discrete stair lift 204. Other implementations are also possible.

In some implementations, the screw drive 504 may include a threaded rod that raise or lower the discrete stair lift 204 in a first direction when the screw drive 504 is rotated in a clockwise direction. The screw drive 504 may lower or raise the step 204 in a second direction that is opposite to the first direction when the screw drive 504 is rotated in a counterclockwise direction. The first direction may be up or down, and the second direction may be the opposite based on the threads of the screw drive 504.

In some implementations, the actuators 210 may be implemented in a variety of ways. The actuator 210 may be hydraulic, pneumatic, or electric. Implemented as a hydraulic actuator, the actuator 210 may include a cylinder or fluid motor that utilizes liquid pressure to facilitate mechanical movement of the step 204. Implemented as a pneumatic actuator, the actuator 210 may use compressed gas instead of liquid. Implemented as an electrical actuator, the actuator 210 may include a motor 502 that converts electrical energy into mechanical torque to rotate the screw drive 504 to lift the step 204. Other implementations are also possible.

The staircase system 100 provides several advantages over conventional assisted movement systems, such as escalators, elevators, and the like. First, because each discrete stair lift 204 may be adjusted independently, the amount of power needed to move the discrete stair lift 204 is much smaller than the amount of power needed to move a carriage (such as an elevator). Additionally, the discrete stair lift 204 may be moved independently, making it possible to have multiple virtual platforms 210 concurrently, moving in the same direction or in opposite directions. Thus, a user need not wait for the carriage to return to a starting position to make use of the virtual platform. In some implementations, a further advantage may be realized in that the staircase system 100 may be implemented as a spiral staircase or in other form factors, depending on the implementation.

The control system 102 in FIG. 1 may control operation of a variety of devices or systems, including the staircase system 200 of FIG. 2, other devices, other systems, or any combination thereof. The operation may vary based on context and based on a variety of parameters, including user preferences, preconfigured patterns, security parameters, other data, or any combination thereof.

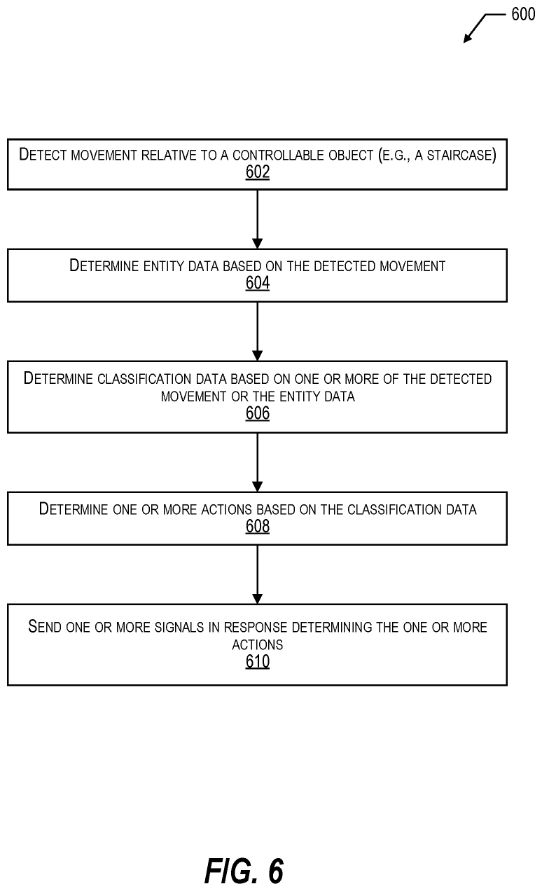

FIG. 6 depicts a flow diagram of a method 600 of initiating one or more actions in response to detecting movement, in accordance with certain embodiments of the present disclosure. At 602, the method 600 may include detecting movement relative to a controllable object. The controllable object may be a staircase formed from a plurality of discrete stair lifts, as described above with respect to FIGS. 1-5. Movement is one possible parameter that may be detected that may be used to trigger a control action. Other parameters may also be determined, including receipt of a radio frequency signal, detection of a voice command, detection of a gesture, detection of optical data, and so on. In some implementations, the parameter may be detected based on data from one or more sensors, from one or more transceivers, or any combination thereof.

At 604, the method 600 may include determining entity data based on the detected movement. Entity data may include size data, speed data, image data, voice data, other data, or any combination thereof. Such data may be determined using optical sensors, microphones, RADAR sensors, LiDAR sensors, other sensors, or any combination thereof.

At 606, the method 600 may include determining classification data based on one or more of the detected movement or the entity data. In some implementations, the classification data may indicate whether the movement involves an entity that is an adult, a toddler, a pet, and so on. In other implementations, the classification data may indicate whether the entity is authorized or not. For example, a first pet may be authorized to ascend the stairs, but another pet that isn't potty trained may not be authorized, and the control system 102 may control the stairs accordingly. In this example, the pet may be classified based on optical data, received radio frequency data, other data, or any combination thereof. In another example, the control system 102 may classify a human approaching the stairs. The human may be a toddler or another who is not authorized to climb the stairs, and the control system 102 may control the discrete step lifts of the staircase to present a barrier. The control system 102 may determine the authorization of the user by performing facial recognition operations based on captured image data as compared to image data of authorized users that were previously stored in memory.

At 608, the method 600 may include determining one or more actions based on the classification data. The one or more actions may include raising or lowering one or more steps, generating alerts, other actions, or any combination thereof. The actions may be determined based on preconfigured settings, other control criteria, or any combination thereof.

At 610, the method 600 may include sending one or more signals in response to determining the one or more actions. The signals may include control signals that may cause actuators to adjust the elevations of one or more discrete stair lifts. In some implementations, the signals may include detectable signals, such as an alert, an email, a phone call, a signal to trigger a visible indicator or an audible indicator, another signal, or any combination thereof. Other implementations are also possible.

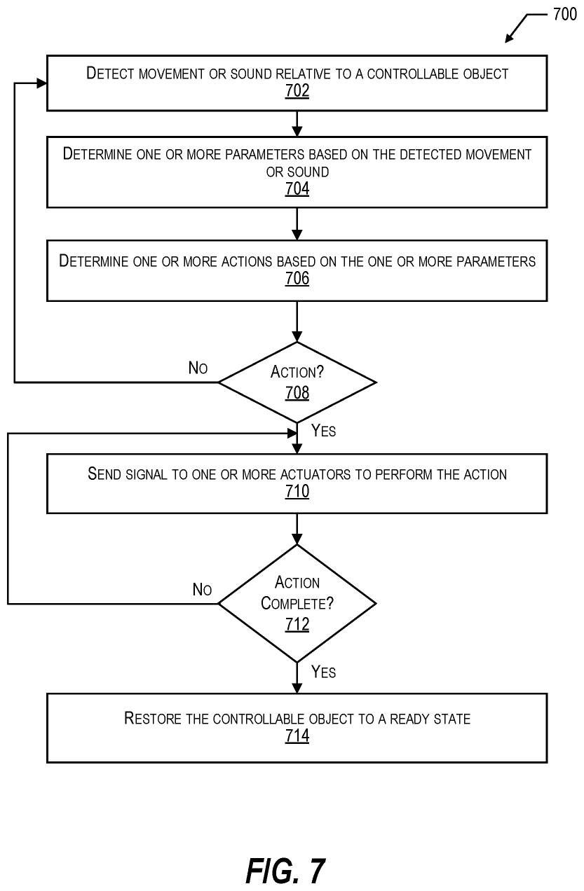

FIG. 7 depicts a flow diagram of a method 700 of initiating one or more actions in response to detecting movement, in accordance with certain embodiments of the present disclosure. At 702, the method 700 may include detecting movement or sound relative to a controllable object, such as a staircase formed from a plurality of discrete stair lifts. The controllable object may be controlled or activated by the control system 102 sending signals to one or more actuators.

At 704, the method 700 may include determining one or more parameters based on the detected movement or sound. The parameters may include a voice command, speed and direction of movement, a gesture, a facial identity, other data, or any combination thereof.

At 706, the method 700 may include determining one or more actions based on the one or more parameters. In one implementation, the one or more actions may include moving one or more discrete stair lifts 204 of a staircase system 200 to provide a virtual platform. The number of discrete stair lifts 204 and the timing of the movement of the discrete stair lifts 204 may be proportional to the speed and direction of a user. In another implementation, the one or more actions may include controlling one or more actuators 210 raise or lower selected discrete step lifts 204 to present a barrier. Other implementations are also possible.

At 708, if no actions are determined, the method 700 may return to 702 to determine movement or sound relative to a controllable object. Otherwise, at 708, if an action is determined, the method 700 advances to 710 and the method 700 includes sending a signal to one or more actuators to perform the action. The signals may include control signals, timing signals, indicator signals, and so on.

At 712, if the action is not complete, the method 700 may return to 710 to send another signal to one or more actuators to perform the action. In an example, the one or more actuators may be controlled to raise the discrete stair lifts 204 to a selected height to present a barrier. In another example, the one or more actuators may raise or lower discrete stair lifts to correspond to the lateral movement of the user, which may include sending multiple elevation control signals according to a timing determined from one or more of the sensors. In this example, the discrete stair lifts may be controlled to change elevations at a specific rate, which may be based on the motion of the user. In still other implementations, the actions may include movements based on actuators 210, alert signals sent by the control system 102 via one or more communication interfaces, and so on.

Otherwise, at 712, if the actions are complete, the method 700 may include restoring the controllable object to a ready state. In an example, one or more actuators 210 may be activated to return the discrete stair lifts 204 of a staircase 202 to default elevations 404. Other implementations are also possible.

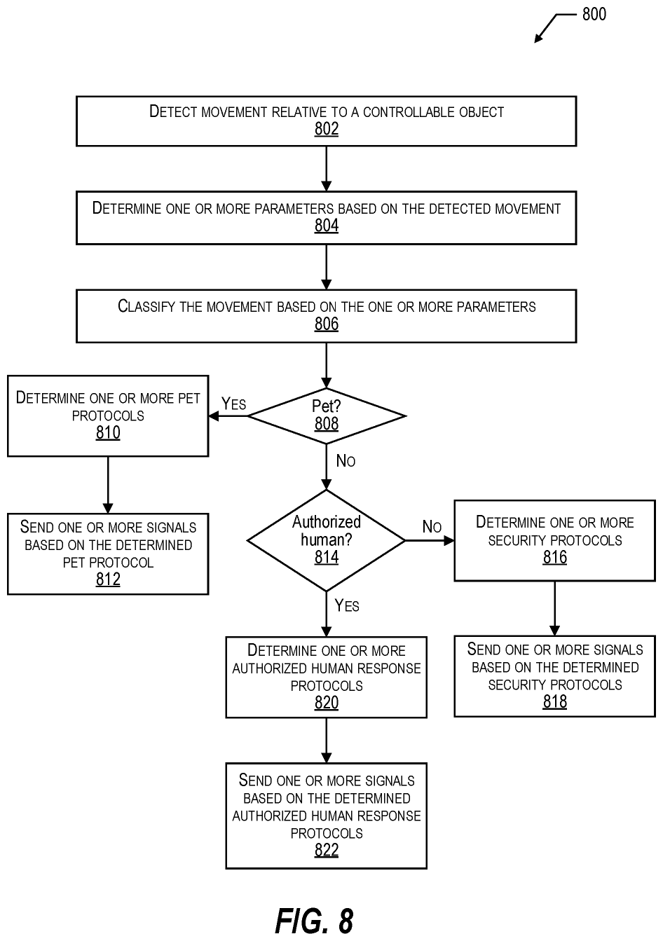

FIG. 8 depicts a flow diagram of a method 800 of implementing different protocols in response to detecting movement, in accordance with certain embodiments of the present disclosure. At 802, the method 800 may include detecting movement relative to a controllable object. Such movement may be associated with a pet, a human, or any combination thereof. The controllable object may include a staircase formed by a plurality of discrete stair lifts 204 (independently controllable steps).

At 804, the method 800 may include determining one or more parameters based on the detected movement. The detected movement may include size data, speed data, direction data, audio data, optical data, other data, or any combination thereof. The parameters may include the user's rate, direction of movement, voice commands, gestures, and so on.

At 806, the method 800 may include classifying the movement based on the one or more parameters. In an example, classifying the movement may include determining whether the movement involves an adult, a toddler, a pet, and so on. In some instances, classifying the movement may include determining whether the person is an authorized adult or child or an authorized pet.

At 808, if the movement data is classified as involving a pet, the method 800 may include determining one or more pet protocols, at 810. The one or more pet protocols may include instructions for adjusting elevations of steps of a staircase 202, other instructions, or any combination thereof. For an elderly pet, the steps may be adjusted to provide a lift to assist the pet between floors. For an unauthorized pet, the steps may be adjusted to present a barrier. At 812, the method 800 may include sending one or more signals based on the determined pet protocol. The signals may include alerts, actuator control signals, other signals, or any combination thereof.

Returning to 808, if the movement data is not classified as involving a pet, the method 800 may include determining if the movement data is associated with an authorized human, at 814. Authorization may be determined by the control system 102 based on facial recognition, voice recognition, size, other data, or any combination thereof. If the movement is not associated with an authorized human, the method 800 may include determining one or more security protocols, at 816. The security protocols may include a sequence of elevations for the discrete stair lifts 204 to present a barrier for a toddler, a pet, or an intruder. In an example, all the discrete stair lifts 204 may be raised or lowered so that the staircase cannot be accessed. Other implementations are also possible.

At 818, the method 800 may include sending one or more signals based on the determined security protocols. The signals include the transmission of an email or a text or may include a phone call to alert the homeowner or a security company, depending on the protocol. In some implementations, the sending of the one or more signals may trigger a security system or alert law enforcement.

Returning to 814, if the human is authorized, the method 800 may include determining one or more authorized human response protocols, at 820. The authorized human response protocols may dynamically changing elevations of discrete stair lifts 204 to provide a selected virtual platform, and so on. Depending on the implementation, the authorized human response protocols may include instructions for various control devices, timing of execution of such instructions, and so on. In some instances, the authorized human response protocol may include identifying an assistive technology, such as a wheelchair or a cane and presenting a virtual platform to assist the user. Alternatively, the authorized human response protocol may include controlling each of the plurality of discrete step lifts 204 to raise or lower the user as he or she advances laterally. Other implementations are also possible.

At 822, the method 800 may include sending one or more signals based on the determined authorized human response protocols. The signals may include control signals for triggering one or more actuators 210 based on the selected protocols. In some instances, the signal may include an alert (such as a text) to another adult in the household. Other implementations are also possible.

In conjunction with the systems, methods, and devices described above with respect to FIGS. 1-8, a system may detect movement or an audio signal corresponding to one or more controllable objects, such as a staircase formed of a plurality of discrete stair lifts. In response to detecting the movement or audio signal, the system may automatically control the controllable object according to a predetermined protocol. The protocols may include pet access protocols, security protocols, authorized human protocols, or any combination thereof. In some implementations, the system may utilize sensor signals from various sensors, including optical signals, RADAR signals, LiDAR signals, audio signals, or any combination thereof, to detect an entity approaching one of the controllable elements. The system may determine the size, speed, direction, or other parameters of the movement. Alternatively, the system may determine a gesture based on the signals. The system may also selectively control the discrete stair lifts to provide a selected operation based on the determined signals. For example, the system may adjust the steps of a staircase to assist a user when the user is authorized. The system may perform no action or may adjust the discrete stair lifts of the staircase to impede a user when the user is not authorized.

In some implementations, the system may implement safety or security features when the system determines that a toddler is approaching the staircase. For example, the system may implement a barrier by raising all the discrete stair lifts or lowering all the discrete stair lifts to render the staircase inaccessible. The system may perform a similar operation in response to detecting an intruder. Other implementations are also possible.

Although the present invention has been described with reference to preferred embodiments, workers skilled in the art will recognize that changes may be made in form and detail without departing from the scope of the invention.

What is claimed is:

1. A system comprising:
an input/output (I/O) interface configured to receive data from one or more sensors and to provide control signals to one or more actuators;
a processor coupled to the I/O interface; and
a memory accessible to the processor, the memory storing instructions that, when executed, cause the processor to:
receive sensor signals from the one or more sensors; and
send actuator signals to the one or more actuators to control movement of a plurality of discrete stair lifts of a staircase based on the received sensor signals.

2. The system of claim 1, further comprising the one or more actuators, each of the one or more actuators associated with a discrete stair lift of the plurality of discrete stair lifts, each of the one or more actuators comprising:
a motor to receive at least one of the actuator signals; and
a screw drive coupled to the motor and configured to raise or lower the discrete stair lift in response to activation of the motor.

3. The system of claim 1, wherein the processor is configured to:
determine a size and speed of an entity moving toward the staircase based on the sensor signals;
determine the entity is one of a pet or a toddler based on one or more of the size or the speed; and
automatically adjust elevations of one or more of the plurality of discrete stair lifts of the staircase to present a barrier to the pet or the toddler.

4. The system of claim 3, wherein the processor is configured to determine the entity is a pet by comparing optical data of the entity to stored images of the pet and by comparing the determined size to stored size data.

5. The system of claim 1, wherein the processor is configured to:
determine one or more of a size, a speed, or a shape of an entity moving toward the staircase based on the sensor signals; and
determine the entity is a human based on the one or more of the size, the speed, or the shape of the entity.

6. The system of claim 5, wherein the processor is configured to:
compare image data associated with the entity to stored image data to determine the human is authorized to access the staircase; and
in response to determining the human is authorized, automatically adjust elevations of one or more of the plurality of discrete stair lifts of the staircase in time with the speed of the human to carry the human from a first elevation to a second elevation as the human moves.

7. The system of claim 5, wherein the processor is configured to:
compare image data associated with the entity to stored image data to determine the human is not authorized to access the staircase; and
in response to determining the human is not authorized, automatically adjust elevations of one or more of the plurality of discrete stair lifts of the staircase to present a barrier to the human.

8. The system of claim 7, wherein the processor is configured to send an alert including image data to one or more devices.

10. The system of claim 1, wherein the processor is configured to:
determine an object to be moved via the staircase based on the sensor signals; and
automatically adjust elevations of one or more of the plurality of discrete stair lifts of the staircase to provide a virtual platform to carry the object from a first elevation to a second elevation.

11. The system of claim 1, wherein the sensor signals correspond to a gesture.

12. A system comprising:
one or more sensors;
one or more actuators;
a processor coupled to the one or more sensors and to the one or more actuators; and
a memory accessible to the processor, the memory storing instructions that, when executed, cause the processor to:
receive sensor signals from the one or more sensors, the sensor signals indicative of movement relative to a staircase comprised of a plurality of discrete stair lifts;
send actuator signals to the one or more actuators to control movement of a plurality of discrete stair lifts of a staircase based on the sensor signals.

13. The system of claim 12, wherein each of the one or more actuators associated with a discrete stair lift of the plurality of discrete stair lifts.

14. The system of claim 12, wherein the processor is configured to:
determine one or more parameters associated with an entity moving toward the staircase based on the sensor signals;
classify the entity based on the one or more parameters; and
automatically adjust elevations of one or more of the plurality of discrete stair lifts of the staircase in response to classifying the entity.

15. The system of claim 12, wherein the processor is configured to classify the entity as a pet by:
comparing optical data of the entity to stored images of the pet to determine a first match;
comparing the determined size to stored size data to determine a second match; and
determining the entity is the pet based on the first match and the second match.

16. The system of claim 12, wherein the processor is configured to classify the entity as an authorized human by:
comparing optical data of the entity to stored data corresponding to the authorized human to determine a match, the stored data including one or more of image data, audio data, size data, motion data, or voice data; and
determining the entity is the authorized human based on the match.

17. The system of claim 12, wherein the processor is configured to:
determine a speed of an entity approaching the staircase; and
in response to determining the speed, automatically adjust elevations of one or more of the plurality of discrete stair lifts of the staircase according to the speed to carry the entity from a first elevation to a second elevation as the entity continues to move.

18. A system comprising:
a staircase comprising a plurality of discrete stair lifts, each discrete stair lift including one or more actuators responsive to control signals to raise or lower the discrete stair lift from a first elevation to a selected elevation;
a control system comprising:
a plurality of sensors;
an input/output (I/O) interface coupled to the one or more actuators of the plurality of discrete stair lifts and to the plurality of sensors;
a processor coupled to the I/O interface; and
a memory accessible to the processor, the memory storing instructions that, when executed, cause the processor to:
receive sensor signals from one or more of the plurality of sensors;
determine a selected operation of a plurality of operations based on the received sensor signals; and
selectively send the control signals to the one or more actuators to control movement of one or more of the plurality of discrete stair lifts to provide the selected operation.

19. The system of claim 18, wherein the selected operation comprises one or more of a platform lift operation, a discrete stair lift operation, and a security operation.

20. The system of claim 18, wherein the processor determines a discrete stair lift operation based on the sensor signals, the discrete stair lift operation to cause the processor to:
determine a speed of a user approaching the staircase;
selectively adjust an elevation of a subset of the plurality of discrete stair lifts to a first elevation corresponding to an elevation associated with the user;
monitor the speed of the user; and
selectively adjust the elevation of the subset and of one or more of the plurality of discrete stair lifts to lift the user from the first elevation to a second elevation as the user moves laterally.
